(19) United States
(12) Patent Application Publication
(10) Pub. No.: US 2018/0325248 A1
(43) Pub. Date: Nov. 15, 2018

(54) Moveable Clip

(71) Applicant: Tedder Industries, LLC, Post Falls, ID (US)

(72) Inventors: Thomas Tedder, Post Falls, ID (US); Drew Stephens, Coeur d'Alene, ID (US); Jacob Shearer, Post Falls, ID (US)

(73) Assignee: Tedder Industries, LLC, Post Falls, ID (US)

(21) Appl. No.: 15/974,509

(22) Filed: May 8, 2018

Related U.S. Application Data
(60) Provisional application No. 62/503,849, filed on May 9, 2017.

(51) Int. Cl. A45F 5/02; F41C 33/04

(52) U.S. Cl. CPC A45F 5/021; F16B 3/00; F41C 33/041

(57) ABSTRACT

Representative implementations of devices and techniques provide a multi-purpose clip. In various embodiments, the clip may be used to temporarily or permanently couple an item to a support object, such as a holster to an article of clothing, for instance. The clip comprises a loop portion arranged to be coupled to the support object and a key portion arranged to be coupled to the supported item, via a keyhole at the supported item.

### PRIORITY CLAIM AND CROSS-REFERENCE TO RELATED APPLICATION

This application claims the benefit under 35 U.S.C. § 119(e)(1) of U.S. Provisional Application No. 62/503,849, filed May 9, 2017, which is hereby incorporated by reference in its entirety.

### BACKGROUND

Implements, such as tools, weapons, and the like, may be encased in a holster for protection of the implement and/or the user, while providing access to the implement. For example, a holster may allow a user to conveniently carry the implement, safely retaining the implement until needed. When the implement is to be used, the user may withdraw the implement from the holster, and then return it to the holster when finished. A holster can be worn on a user's person with the aid of belt clips, or the like, which can temporarily couple the holster to an article of the user's clothing In various examples, a holster can be worn on a belt or strap, for instance, either in public view or concealed from view.

Holster belt clips can be attached to a holster using threaded hardware and screws, for instance. However, the screws can disengage themselves over time and with use, due to the movement of the clips while the holster is worn on a person. This can become a problem if the screws are allowed to back fully out of the coupling hardware and become lost, making the holster not function properly. Sometimes a thread locking compound (such as Loctite®, for instance) can be applied to the screws to keep them in place. However, the locking compound generally prevents the screws from being removed, including to move the holster clips to different positions on the holster to adjust the height or angle of the holster, for example.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items.

For this discussion, the devices and systems illustrated in the figures are shown as having a multiplicity of components. Various implementations of devices and/or systems, as described herein, may include fewer components and remain within the scope of the disclosure. Alternately, other implementations of devices and/or systems may include additional components, or various combinations of the described components, and remain within the scope of the disclosure. Shapes and/or dimensions shown in the illustrations of the figures are for example, and other shapes and or dimensions may be used and remain within the scope of the disclosure, unless specified otherwise.

FIGS. 1A-1C include front, back, and side views, respectively, of an example clip, according to an embodiment.

FIGS. 2A-2D include perspective views of the example clip of FIG. 1, according to an embodiment.

FIG. 3A is a close perspective view of a male key portion, according to one embodiment.

FIG. 3B is a close perspective view of a female key opening, according to the embodiment.

FIGS. 4A-4D show back perspective views of four examples of clips, according to four embodiments.

FIGS. 5A-5D show front perspective views of four examples of clips, according to the four embodiments.

FIGS. 6A-6D show side views of four examples of clips, according to the four embodiments.

FIGS. 7A-7E show a graphical flow sequence of an example technique for adjusting a clip, according to an embodiment.

FIGS. 8A-8C show a graphical flow sequence of an example application of a pair of clips, according to an embodiment.

### DETAILED DESCRIPTION

### Introduction

Representative implementations of devices and techniques provide a multi-purpose clip. In various embodiments, the clip may be used to temporarily or permanently attach an item (such as a handgun holster, for example) to a support object (such as a belt of a user, for example). While hanging from or attached to the support object, the clip can hold the holster, or any other type of load. In alternate implementations, the clip may be used to attach various items to varying locations or objects as desired.

In the examples illustrated, the clip may be used to temporarily couple a holster for a weapon, tool, or other implement to an article of a user's clothing, for carrying the holster on the user's person. In other implementations, the clip may be used for suspending or supporting various other items, including suspending items from an article of the user's clothing, or from any other support location that the clip fits onto.

In various examples, the clip includes a unique key feature that can interface with a similarly shaped key opening (on the holster or other item to be supported). The combination key/keyhole pair allows the clip to be quickly and easily installed, removed, and adjusted relative to the supported item. In one embodiment, the clip includes an extension that can be used with the clip to adjust a support position and/or an orientation of the supported item.

Techniques and devices are discussed with reference to example handgun holsters illustrated in the figures, as an example supported item. However, this is not intended to be limiting, and is for ease of discussion and illustrative convenience. The techniques and devices discussed may be applied to any of various cases, case designs, combinations, and the like, (e.g., holsters, sheaths, covers, cases, carriers, scabbards, etc.) for encasing tools, weapons, or other implements, and remain within the scope of the disclosure.

Further, the techniques and devices are discussed and illustrated generally with reference to an inside waistband (IWB) style holster. This is also not intended to be limiting. In various implementations, the techniques and devices may be employed with outside waistband (OWB) holsters, as well as holsters worn at the back, chest, side, thigh, or ankle of a user, holsters carried in a bag, purse, or pocket, or carried or worn on a belt, a strap, or in any other manner (e.g., attached to a vehicle, an object of furniture, another object, etc.). In various other implementations, the techniques and devices may be employed with other devices, systems, instruments, tools, implements, or the like (hereinafter “supported items”).

Implementations are explained in more detail below using a plurality of examples. Although various implementations and examples are discussed here and below, further implementations and examples may be possible by combining the features and elements of individual implementations and examples.

### Example Clip

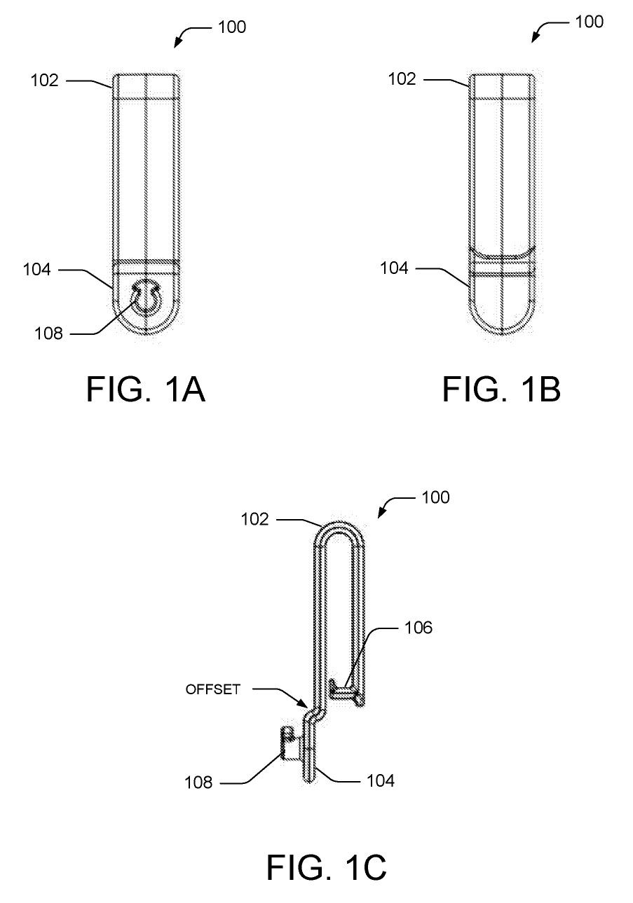

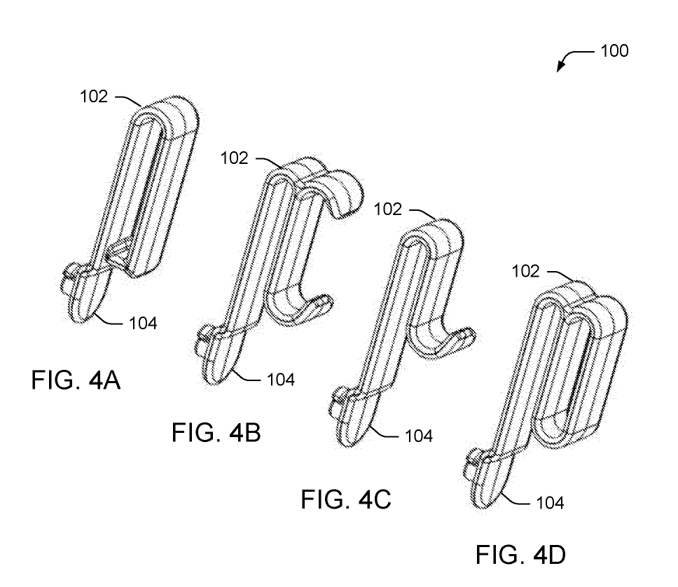

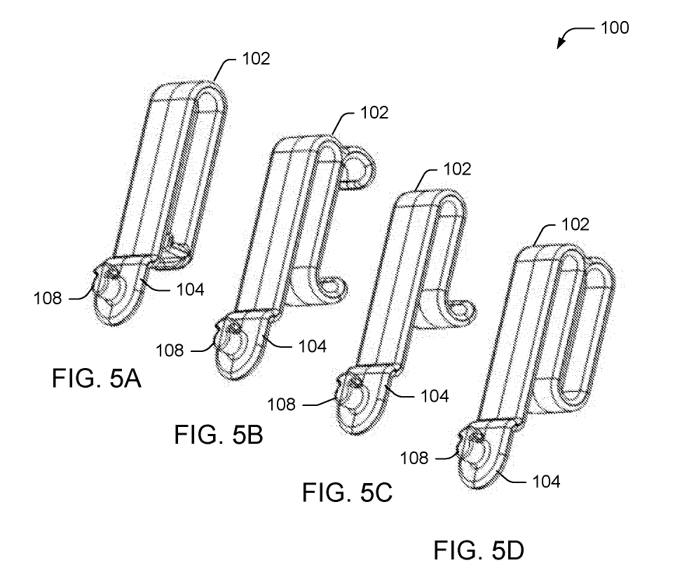

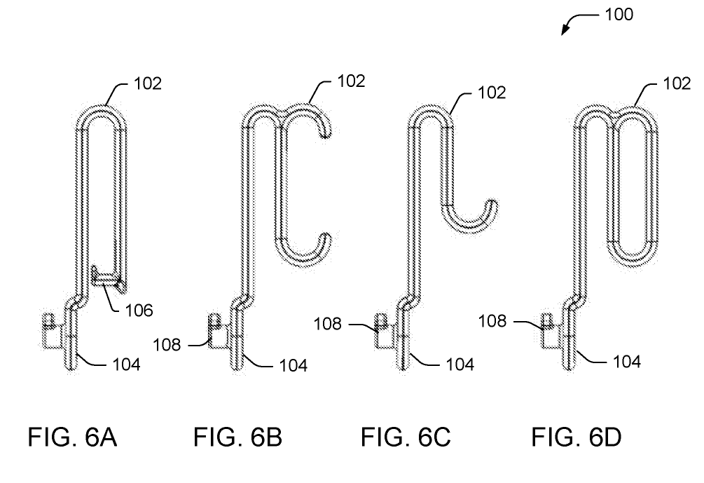

An example clip 100, as shown in FIGS. 1A-8C, includes a loop portion 102 and a key portion 104. In various implementations, the loop portion 102 can have a generally hooked shape, including a looped shape, a “D” shape, a “G” shape, an inverted “U” shape (see for example FIGS. 1A-2D and FIGS. 4A, 5A, and 6A), a “C” shape (see for example FIGS. 4B, 5B, and 6B), a “J” shape (see for example FIGS. 4C, 5C, and 6C), an “O” shape (see for example FIGS. 4D, 5D, and 6D), and so forth, and/or combinations of two or more of these and other shapes. Clips 100 having other shapes of loop portions 102, including shapes that are combinations of the illustrated shapes of FIGS. 1A-6D are also included in the scope of this disclosure.

The loop portion 102 is arranged/configured to clip onto or around a support object, such as a belt or strap worn by a user, or any other support object that the loop portion 102 fits onto. In some embodiments, as shown in FIG. 1C, the loop portion 102 includes a catch 106, a barb, a trap, or other mechanism for holding onto the support object. In alternate implementations, the loop portion 102 can be permanently or temporarily coupled to any sort of support that fits within the shape of the loop portion 102. In various embodiments, the loop portion 102 may be formed to have any dimensions desired for an intended use (or for a general use).

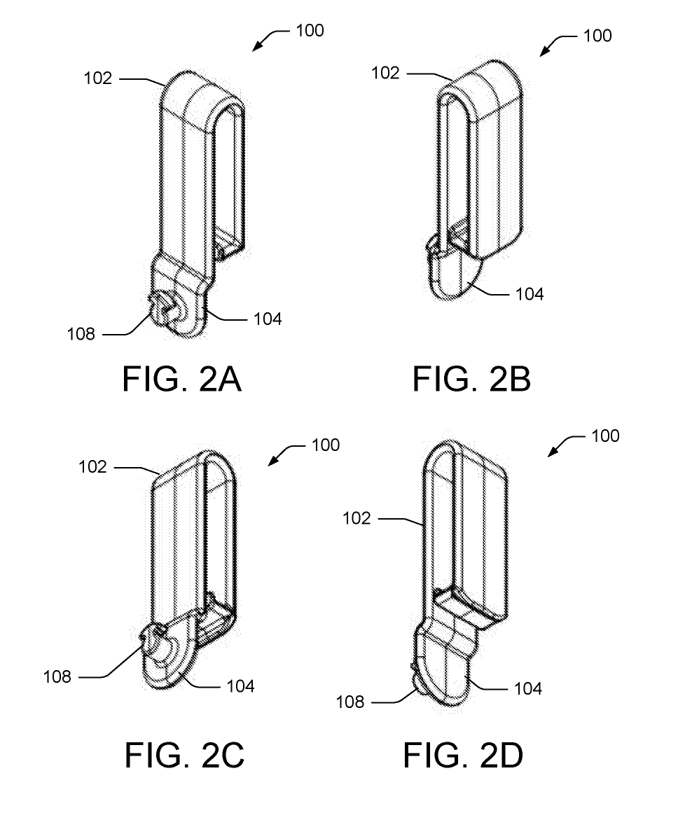

As shown in FIGS. 1A-2D, in many embodiments, the key portion 104 is coupled to the loop portion 102 or is integral to the loop portion 102. The key portion 104 is arranged to attach the loop portion 102 to the supported item. For example, in some embodiments, the key portion 104 is arranged to be temporarily or permanently coupled to the supported item. In an implementation, as shown in FIG. 1C, the key portion 104 may be offset from the loop portion 102. The offset can provide clearance for desired movement (e.g., pivot and rotation) of the clip 100 while the holster is worn on the user, or for adjusting the clip 100, as described below. In other embodiments, no offset is present.

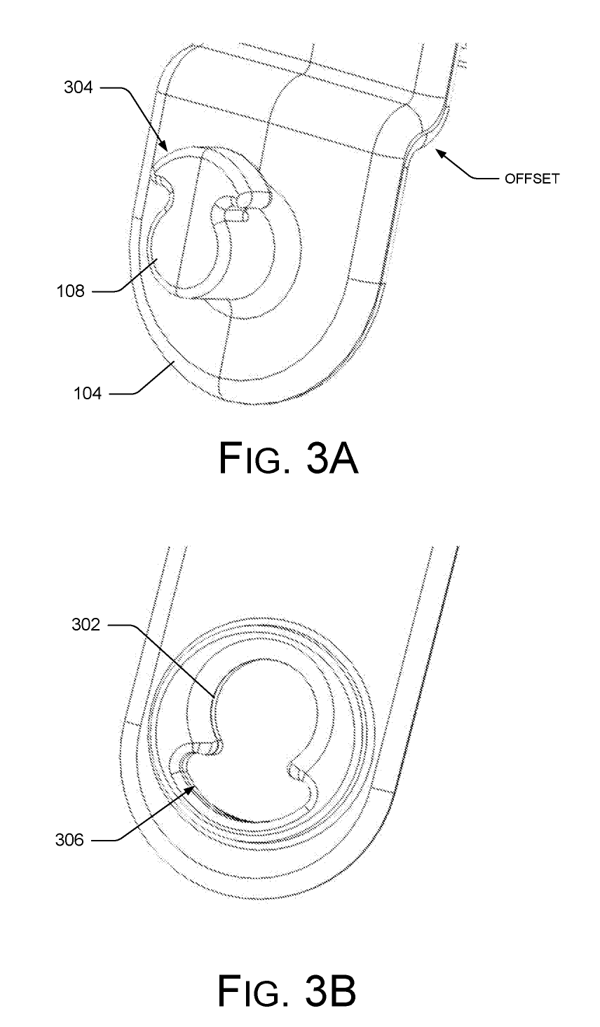

In various embodiments, as shown in FIG. 3A, the key portion 104 includes one or more uniquely shaped interface features, such as a key 108, or the like (e.g., post, tab, shaft, etc.) for interfacing with the supported item and/or for adjusting a position (or an effective length) of the clip 100. In the embodiments, the key 108 includes a unique shape that matches the shape of a female feature, such as a keyhole 302, or the like (e.g., cavity, channel, rail, slot, guide, etc.) located at one or more portions of the supported item. This combination of the key 108 and the keyhole 302 offers quick and easy connection and disconnection of the clip 100 to the supported item (e.g., holster backer 802) with no tools required. The keyholes 302 of the supported item are receivers for the key 108 of the clip 100, allowing quick connect/disconnect of the clip 100 to the supported item.

As shown in FIGS. 3A and 3B, the unique shape of the male key 108 on the clip 100 closely matches the shape of the female keyhole 302 feature. The key 108 shape and keyhole 302 shape may have various shapes, and may be any suitable shape that allows the locking function described herein. For example, the key 108 may include one or more uniquely shaped tab portions 304 that closely fit equally shaped slot portions 306 of the keyhole 302 when aligned. Accordingly, a clip 100 is attached to the supported item (e.g., holster, etc.) by aligning the unique shape of the male key 108 with a like shape of a female keyhole 302 on the holster, for example, inserting the key 108 through the keyhole 302, and then rotating the clip 100 to engage the key 108 and prevent non-intentional disconnection. In various embodiments, the rotation may be varying degrees (30, 45, 60, 90, 180, etc., or any rotational degree beyond 0 degrees) to lock the key 108 in the keyhole 302.

The shape of the key 108 is closely matched to the shape of the keyhole 302, so the key 108 must be aligned well to the keyhole 302 to pass through the keyhole 302, and will not pass through the keyhole 302 if offset, misaligned, or rotated out of alignment. Accordingly, the shape of the key 108 with respect to the keyhole 302 also prevents the key 108 from backing out of the keyhole 302 once the clip 100 has been inserted and rotated. For example, the tab portion 304 of the key 108 is blocked from coming through the featured opening of the keyhole 302, unless the tab portion 304 is precisely aligned to the slot portion 306 of the keyhole 302.

To remove the key 108 (and thus the clip 100), the clip 100 is rotated, which rotates the key 108, to realign the key 108 with the keyhole 302. Once the shape of the key 108 is aligned to the shape of the keyhole 302, the key 108 can then be pulled from the keyhole 302. This removes the clip 100 from the supported item, without the use of tools.

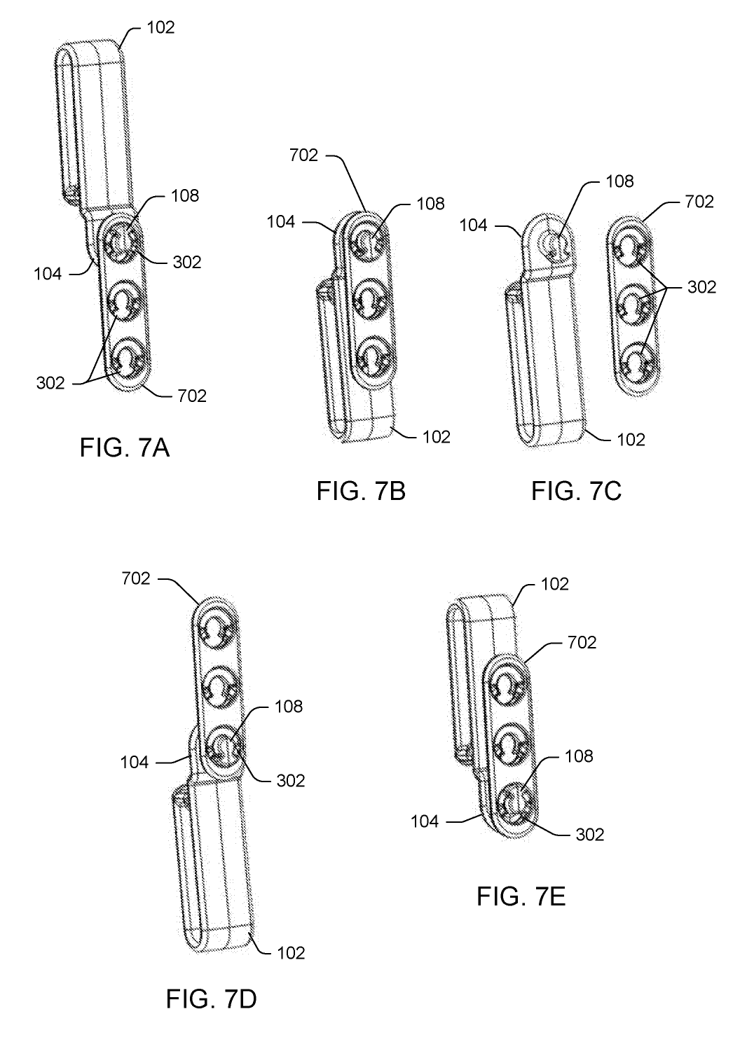

In an implementation, as shown in FIGS. 7A-7E, the clip 100 includes a base connector 702. In various embodiments, the base 702 is arranged to provide a connection point for the clip 100, or to extend or to adjust a reach of the clip 100. In the embodiments, the base 702 includes an elongated section with a plurality of keyholes 302. As shown in FIGS. 7A-7E, the base 702 may include three keyholes 302, and in alternate embodiments, the base 702 may include fewer or more keyholes 302. In one embodiment (not shown) the base 702 includes at least one key 108.

In various embodiments, the base 702 can be used to couple various carriers or accessories (e.g., flashlight, magazine, knife, etc.) together, to the clip 100, to the holster backer 802, or to other support objects (e.g., a user's belt, backpack, etc.) having a key 108, a keyhole 302, or a combination. In an alternate embodiment, more than one base 702 may be coupled to a clip 100, a holster backer 802, or other support object.

In an implementation, the base 702 can be used to extend a reach of the clip 100 when the clip 100 is coupled to one of the keyholes 302 of the base 702 (as shown in FIG. 7A), and the supported item is coupled to another of the keyholes 302 of the base 702. The longest reach can be achieved when the clip 100 and the supported item are coupled at opposite extents of the base 702.

The reach of the clip 100 can be adjusted by moving the key 108 of the clip 100 to another of the keyholes 302 of the base 702, for example. This adjustment sequence is illustrated graphically in FIGS. 7A-7E. At FIG. 7A, the key 108 of the clip 100 is coupled to a keyhole 302 at a first end of the base 702. To begin removing the key 108 from the keyhole 302, the clip 100 is rotated (for example 180 degrees) to align the shape of the key 108 to the shape of the keyhole 302, as shown in FIG. 7B. With the correct alignment, at FIG. 7C, the key 108 is removed from the keyhole 302 at the first end of the base 702.

As shown at FIG. 7D, the base 702 is moved so that another keyhole 302 is aligned to the key 108 of the clip 100. With the shape of the key 108 aligned to the shape of the new keyhole 302, the key 108 is inserted into the new keyhole 302 of the base 702. As shown at FIG. 7E, the clip 100 is rotated (for example 180 degrees) with the key 108 in the new keyhole 302 to lock the key 108 in the new keyhole 302. The amount of rotation used to unlock and to lock the key 108 with respect to the keyhole(s) 302 depends on the orientation of the shape of the key 108 on the clip and the orientation of the keyhole 302 on the base 702 (or the supported item).

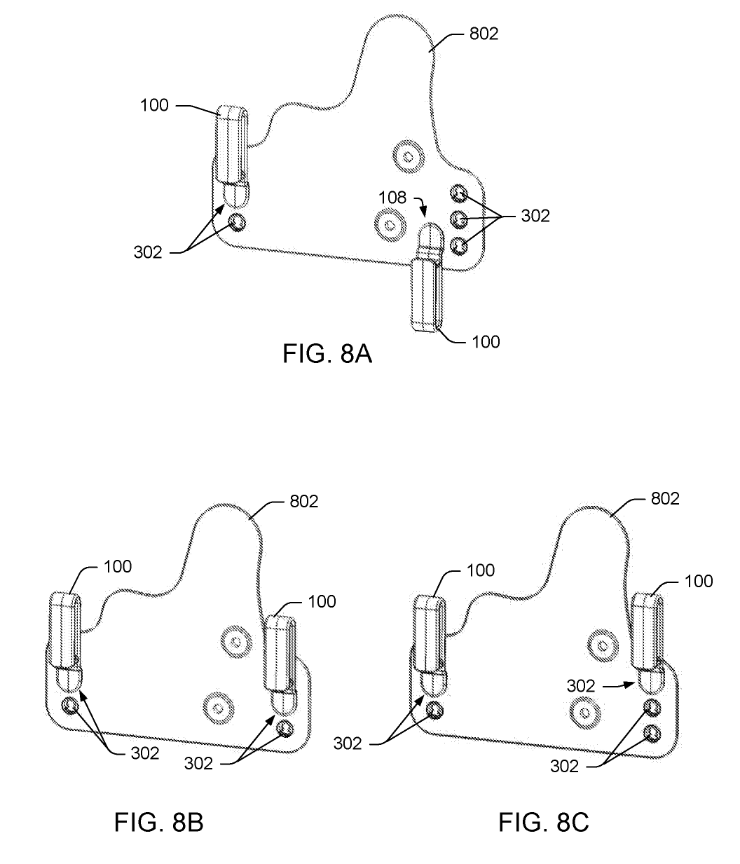

As shown in FIGS. 8A-8C, the clips 100 (and the bases 702) may be coupled to a holster backer 802 (or a holster, etc.) having one or more keyholes 302, to suspend the holster backer 802 (or the holster, etc.) from an article of a user's clothing, a support object, or the like. As shown in FIG. 8A, the clip 100 may be positioned relative to a selected keyhole 302 so that the shape of the key 108 of the clip 100 is aligned to the shape of the keyhole 302. As shown in FIG. 8B, the clip 100 is rotated (180 degrees for example) after inserting the key 108 of the clip 100 into the selected keyhole 302, to lock the clip 100 to the holster backer 802. In the locked configuration, the clip 100 is allowed to pivot, but is not allowed to back out of the holster backer 802, unless the clip 100 is intentionally rotated into the correct alignment with the keyhole 302.

As shown in FIGS. 8A-8C, a holster assembly can be reconfigured or adjusted as desired without the use of tools. For example, the clips 100 can be moved to different keyhole 302 positions on the backer 802 to adjust the carry angle, or cant of the holster. In various embodiments, the backer 802 includes multiple female keyholes 302 at different positions of the backer 802. The multiple keyhole 302 positions allow the user to select different cants or positions for the holster, based on the keyholes 302 selected for the clip 100 connections. This allows the user to adjust the cant of the holster or carrier as desired for comfort or function.

For example, FIG. 8B shows the clips 100 positioned for a level carry of the holster backer 802. One or more of the clips 100 can be moved to a different keyhole 302 to adjust the carry angle, as shown in FIG. 8C. Further adjustments can be made with the base 702 (which may include at least one key 108, or alternately, the backer 802 may include one or more keys 108).

The quick change clips 100 also allow the user to quickly interchange and adjust the clips 100 onto different support items, without tools. For example, the user may change the clips 100 from the backer 802, for instance, onto holsters, holster backers, accessory carriers, accessory backers, etc. as desired. Moving the clips 100 to another holster backer 802, magazine accessory, or the like, includes removing the clips 100 from the backer 802 and attaching the clips 100 to another backer, holster, etc. This can be done by a user in the field, disengaging the clips 100 from the backer 802 as described above, and engaging the clips 100 to the replacement backer.

In alternate embodiments, the clip 100 may include a female keyhole 302 arranged to engage with a male key 108 on a base 702, a holster backer 802, or other supported item. For further user convenience, the clip 100 and the base 702, holster backer 802, or other supported item may each include a combination of male keys 108 and female keyholes 302 in some embodiments.

In various implementations, the clip 100 and the base 702 are comprised of various plastics, composites, metals, combinations of the same, or the like. For example, the clip 100 and the base 702 may be comprised of a polyamide, or similar material. In various embodiments, the clip 100 and the base 702 have rigidity and stability properties based on a particular material selected for the clip 100 and the base 702. For example, some materials that may be used include styrenic block copolymers (TPE-s), polyolefin blends (TPE-o), elastomeric alloys (TPE-v or TPV), thermoplastic polyurethanes (TPU), Thermoplastic copolyesters, thermoplastic polyamides, various metals and alloys, fiber composites, combinations of the same, and the like. Additionally, in some embodiments, the stability properties are also based on a thickness of the clip 100 and the base 702.

As discussed above, the techniques, components, and devices described herein with respect to the implementations are not limited to the illustrations of FIGS. 1A-8C, and may be applied to other devices and designs, without departing from the scope of the disclosure. In some cases, additional or alternative components, techniques, sequences, or processes may be used to implement the techniques described herein. Further, the components and/or techniques may be arranged and/or combined in various combinations, while resulting in similar or approximately identical results. It is to be understood that a clip 100 and/or a base 702 may be implemented as a stand-alone device or as part of another system (e.g., integrated with other components). In various implementations, additional or alternative components may be used to accomplish the disclosed techniques and arrangements.

### CONCLUSION

While various discreet embodiments have been described throughout, the individual features of the various embodiments may be combined to form other embodiments not specifically described. The embodiments formed by combining the features of described embodiments are also within the scope of the disclosure.

What is claimed is:

1. An apparatus, comprising:
a loop portion arranged to clip onto or around a support object and to support a supported item;
a key portion coupled to or integral to the loop portion and arranged to removably attach the loop portion to the supported item; and
a key coupled to or integral to the key portion and protruding from the key portion, the key having a featured shape arranged to match a shape of a keyhole at the supported item, the key arranged to removably lock the key portion to the supported item when the key is rotated while inserted into the keyhole.

2. The apparatus of claim 1, further comprising a catch coupled to or integral to the loop portion, the catch arranged to trap the support object within the loop portion when the loop portion is clipped onto or around the support object.

3. The apparatus of claim 1, further comprising a base connector having one or more keyholes arranged to match the shape of the key, the base connector arranged to removably couple the loop portion to the supported item.

4. The apparatus of claim 3, wherein the base connector includes a plurality of keyholes and is arranged to adjust a reach of the loop portion based on selecting one keyhole of the plurality of keyholes for inserting the key of the key portion and selecting another keyhole of the plurality of key holes for the supported item.

5. The apparatus of claim 4, wherein the base connector includes at least one key and is arranged to adjust a reach of the loop portion based on selecting one keyhole of the plurality of keyholes for inserting the key of the key portion and selecting the key of the base connector for the supported item.

6. The apparatus of claim 1, wherein the key is prevented from being inserted into the keyhole or from being removed from the keyhole while inserted into the keyhole unless the featured shape of the key is aligned with the shape of the keyhole.

7. The apparatus of claim 1, wherein the key portion is offset from the loop portion to allow a rotational movement of the key portion while the key is inserted into the keyhole.

8. The apparatus of claim 1, wherein the key protrudes from the key portion normal to the key portion.

9. The apparatus of claim 1, wherein the key includes one or more shaped tabs arranged to fit corresponding one or more slots of the keyhole when the key is aligned to the keyhole.

10. A holster clip, comprising:
a loop portion arranged to clip onto or around an article of clothing or an accessory and to support an implement holster;
a key portion coupled to or integral to the loop portion and arranged to removably attach the loop portion to the implement holster; and
a key coupled to or integral to the key portion and protruding from the key portion, the key having a featured shape arranged to match a shape of a keyhole at the implement holster, the key arranged to removably lock the key portion to the implement holster when the key is rotated while inserted into the keyhole.

11. The holster clip of claim 10, further comprising a base connector having one or more keyholes arranged to match the shape of the key, the base connector arranged to removably couple an accessory having a key or a keyhole to the holster clip or to the implement holster.

12. The holster clip of claim 11, wherein the base connector includes at least one key arranged to match a keyhole of the accessory and a keyhole of the implement holster.

13. The holster clip of claim 10, wherein the key portion is arranged to pivot relative to the implement holster without unlocking the key portion from the implement holster.

14. The holster clip of claim 10, wherein the key is arranged to be inserted into the keyhole when the loop portion is at a first rotational angle relative to the implement holster, the loop portion in an inverted orientation or an offset orientation while at the first rotational angle, and wherein the key is arranged to lock the key portion to the implement holster when the loop portion is at a second rotational angle relative to the implement holster, the loop portion in an upright orientation while at the second rotational angle.

15. The holster clip of claim 10, wherein the key is arranged to unlock the key portion from the implement holster when the key is rotated further while inserted into the keyhole, until the featured shape of the key is aligned to the shape of the keyhole.

16. The holster clip of claim 10, wherein a combination of the key and the keyhole comprises a tool-less quick-connect and a tool-less quick-disconnect for the holster clip relative to the implement holster.

17. The holster clip of claim 16, wherein a combination of the key and a plurality of keyholes is arranged to allow a user to adjust a ride height and a cant of the implement holster without the use of tools, when the implement holster includes the plurality of keyholes.

18. The holster clip of claim 17, wherein the ride height and the cant of the implement holster is arranged to be adjusted by moving the key from a first keyhole of the plurality of keyholes to a second keyhole of the plurality of keyholes, without the use of tools.

19. A holster clip, comprising:
a loop portion arranged to clip onto or around an article of clothing or an accessory and to support an implement holster, the loop portion including a catch coupled to or integral to the loop portion, the catch arranged to trap the article of clothing or the accessory within the loop portion when the loop portion is clipped onto or around the article of clothing or the accessory;
a key portion coupled to or integral to the loop portion and arranged to removably attach the loop portion to the implement holster, the key portion offset from the loop portion; and
a key coupled to or integral to the key portion and protruding from the key portion normal to the key portion, the key having a featured shape arranged to match a shape of a keyhole at the implement holster, the key arranged to removably lock the key portion to the implement holster when the key is rotated while inserted into the keyhole.

20. The holster clip of claim 19, further comprising a base connector having an elongated section with one or more keyholes arranged to match the shape of the key, the base connector arranged to adjust a reach of the holster clip.
